(19) United States
(12) Patent Application Publication
(10) Pub. No.: US 2023/0256573 A1
(43) Pub. Date: Aug. 17, 2023

(54) TOOL COMPONENTS QUICK CONNECT INTERFACE SYSTEM

(71) Applicant: Johnny's Selected Seeds, Winslow, ME (US)

(72) Inventors: Bradford P. Waugh, Decatur, GA (US); Jennifer M. Goff, Woolwich, ME (US); Stephen M. Whitworth, Brunswick, ME (US)

(21) Appl. No.: 17/673,101

(22) Filed: Feb. 16, 2022

(51) Int. Cl. B25B 23/00

(52) U.S. Cl. CPC B25B 23/0035

(57) ABSTRACT

A quick connect tool interface system including a tool handle component including a handle body with a tool shank engagement section at an end thereof, wherein the tool shank engagement section includes a shank cavity and a coupling button. The tool handle component is arranged for reversible engagement with a farming or landscaping tool implement with a tool shank having a tool shank modification, wherein the tool shank modification includes a button connector. The coupling button of the tool handle component is spring-loaded and configured with a shank retention bar arranged for reversible engagement with the button connector of the tool shank modification, which may be a slot or a notch but not limited thereto.

### BACKGROUND OF THE INVENTION

### 1. Field of the Invention

The present invention relates to tool interface connectors. More particularly, the present invention relates to quick connect/disconnect systems sockets. Still more particularly, the present invention relates to a quick connect interface system configured to enable easy attachment and detachment of a tool implement and a handle component. The tool may be used for farming, landscaping, or cleaning, but not limited thereto.

### 2. Description of the Prior Art

Small-scale farming is a reasonable alternative to the mass production of food and other gardened items available through corporate farms. Organic growers, market gardeners, local-supply farms, and home gardeners can all generally be characterized as small-scale farmers. For the purpose of describing the present invention, small-scale farming involves the use of hand tools that include for example, but are not limited to, tillers, cultivators, trowels, hoes, and weeders. Landscaping similarly involves the use of hand tools that include for example, but are not limited to rakes, lawn aerators and brooms. These sorts of tools have been used for a very long period of time. The tools include a handle component and an implement component. In many instances, the two components are permanently joined together. In other instances, the handle component and implement component are detachable from one another. In that way, different farm implement components may be detachably joined to the handle component and vice versa. This enhances tool usage flexibility and minimizes tool replacement expenses.

There exists in the marketplace modular tool products that comprise a handle component that can be detachably connected to a range of implement components. It has been observed that the joining interface between the handle and the implement can be difficult to operate and/or can result in unintended detachment while in use. In particular, affixing the two components together may be incomplete, the joined components may become stuck together so that detachment does not occur when desired, or a combination of the two. What is needed is a modular tool system that allows for the exchange of different implement components with a handle component. Further, what is needed is a modular tool system with a quick connect interface system between the handle component and the implement component. The system must be easy to use, with reliable attachment and detachment of the tool components.

### SUMMARY OF THE INVENTION

It is an object of the present invention to provide a modular tool system that allows for the exchange of different farm tool implement components with a handle component. It is also an object to provide such a modular tool system with a novel quick connect interface system between the handle component and the implement component. The invention is easy to use, with reliable attachment and detachment of the tool components.

These and other objects of the invention are achieved with a versatile set of farm tools comprising an interface system in which one end of a handle component is configured to engage with a first end of an implement component wherein the implement component is selectable. The handle component includes a handle body that includes a tool shank engagement section at the first end thereof. The engagement section includes a shank cavity and a depressible coupling button. The coupling button includes a shank pass-through port and spring system. The coupling button includes a shank locking connector. The implement component includes an interface section at the first end thereof. The interface section includes a tool shank configured for detachable insertion into the shank cavity of the tool shank engagement section of the handle component. In an embodiment of the invention, the tool shank includes a slotted or notched contact point to accept the coupling button locking feature.

The interface system of the tool of the present invention secures the handle component and the implement component with a novel quick connect mechanism. The coupling button is spring-loaded and positioned so that when depressed the tool shank can be withdrawn from the shank cavity. When the coupling button is released, the spring system returns to its natural state and thereby maintains the shank engagement in the shank cavity.

The interface system ensures ease of use of the tool of the present invention. Any hand tool implement of interest may be modified to include the implement interface section described. The handle component is easy to fabricate and ensures ease of use with the button that allows for quick and secure connection as well as quick disconnection. These and other advantages of the invention may be noted upon review of the following detailed description.

### BRIEF DESCRIPTION OF THE DRAWINGS

FIG. 1 is a side view of an embodiment of the farm tool quick connect interface system of the present invention showing the handle component in cutaway prior to implement component insertion.

FIG. 2 is a side view of the interface system of FIG. 1 with the handle component and implement component engaged together.

FIG. 3 is an exploded of the interface system of the present invention.

FIG. 4 shows an optional element of the implement component shank for implement organization and management.

### DETAILED DESCRIPTION OF THE INVENTION

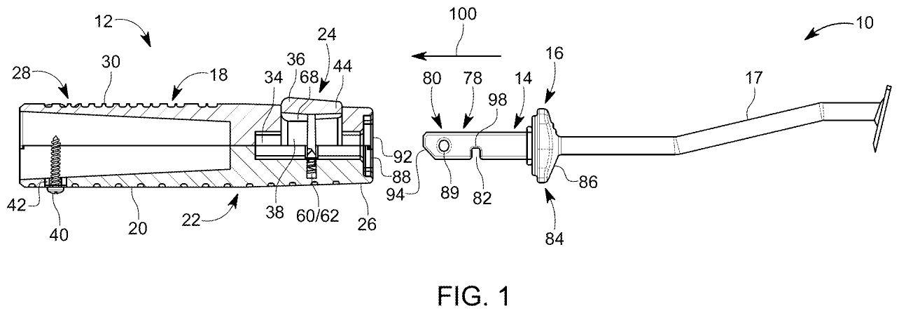

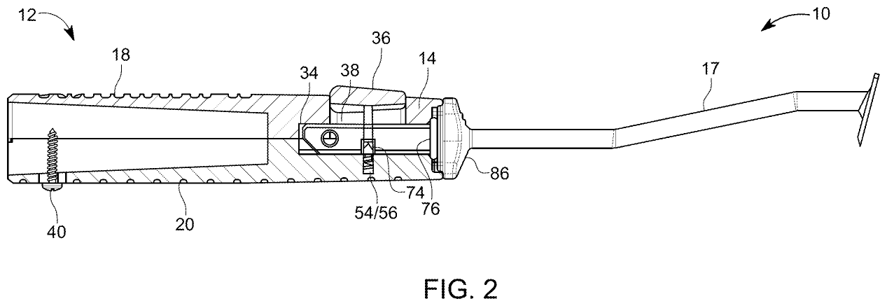

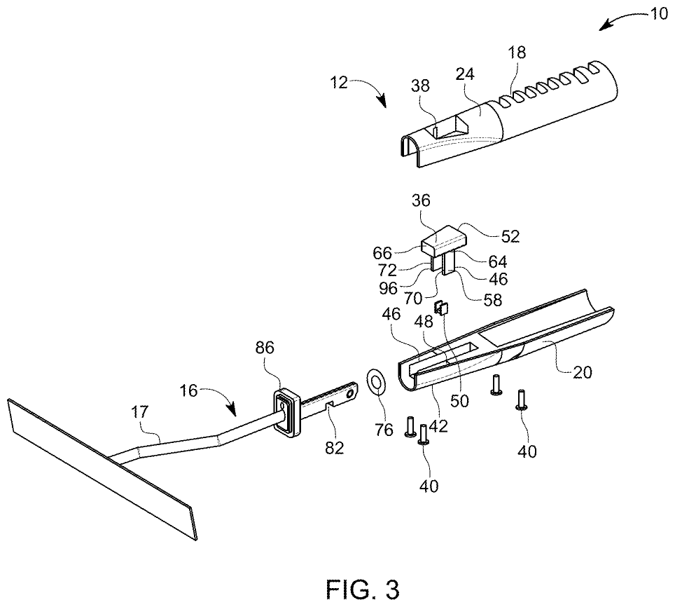

A farm tool quick connect interface system 10 of the present invention is shown in FIGS. 1-3. It is to be understood that this is an example configuration of the systems 10 and is not intended to be limiting. The system 10 may be used to establish an array of handheld farm tools. The system includes a handle component 12 and a tool shank modification 14 of tool shank 16. The tool shank 16 is represented as part of implement 17, which may be any sort of handheld farm implement. The handle component 12 may be a unitary piece or it may be formed of an interlocking set of a first ferule handle part 18 and a second ferule handle part 20 that when joined together form a handle body 22. A first end 24 of the handle component 12 includes a tool shank engagement section 26. A second end 28 of the handle component 12 includes a grasping portion 30 to be held in maneuvering implement 17 when the handle component 12 and tool shank 16 are engaged with one another.

The shank engagement section 26 includes a shank cavity 34 and a coupling button 36. The shank cavity 34 is formed as a cavity in the first handle part 18 of the handle body 22. The coupling button 36 is arranged to moveably extend through button portal 38 of the second part 20 of the handle body 22. With the first handle part 18 and the second handle part 20 engaged together, such as by screwing screws 40 through screw ports 42 of the first handle part 18 into the second handle part 20, the coupling button 36 is captured therebetween with button head 44 extending through the button portal 38.

The shank cavity 34 of the engagement section 26 includes a shank receiving slot 46 and a button retention slot 48 that is substantially traverse to the shank receiving slot 46. The button retention slot 48 is configured to retain therein a pair of springs 50. The coupling button 36 includes upper body 52, shank retention leas 54 and 56, shank retention bar 58, and spring pins 60 and 62. The upper body 52 includes the button head 44 that extends through the button portal 38. First ends 64 and 66 of the shank retention legs 54 and 56 are affixed to an underside 68 of the upper body 52 and are spaced from one another. Second ends 70 and 72 of the shank retention legs 54 and 56 are affixed to the shank retention bar 58. The spring pins 60 and 62 are spaced from one another and are affixed to underside 74 of the shank retention bar 58. The springs 50, the spring pins 60 and 62, the shank retention legs 54 and 56, and the shank retention bar 58 are arranged for movable retention in the button retention slot 48. The first end 24 of the handle component 12 may include an optional gasket such as an O-ring 76 for sealing the interface between the tool shank modification 14 and the handle component 12.

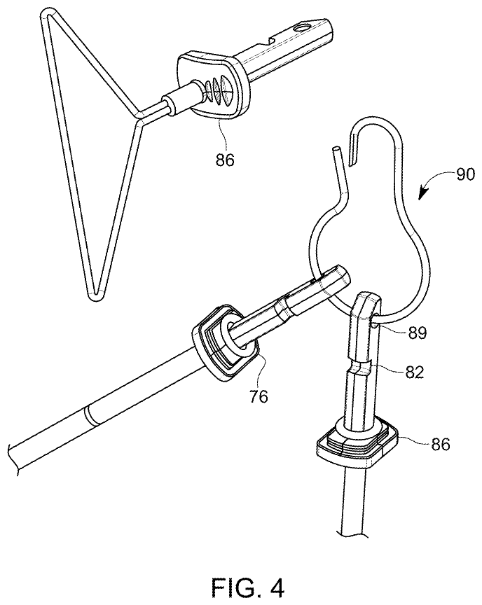

The tool shank modification 14 includes an interface section 78 at first end 80 thereof. The interface section 78 is configured for detachable engagement of the tool shank 16 with the handle component 12. Specifically, the interface section 78 is arranged for insertion into the shank cavity 34. The tool shank modification 14 includes a button connector 82. The button connector 82 may be a notch in the shank modification 14 and may be referred to herein as notch 82. The tool shank modification 14 includes at second end 84 thereof a stem bar 86 that is configured for engagement with stem cavity 88 of the handle component 12. The stein bar 86 when engaged in stem cavity 88 reduces any loose movement of the tool 17 with respect to the handle component 12. The tool shank modification 14 optionally includes a tool management port 89 that can be used to secure the tool 17 to ring 90 shown in FIG. 4 when the tool 17 is not engaged with the handle component 12. For example, the tool management port 89 can be used to secure the tool 17 to a storage or carrying device.

The interface system 10 effectively secures the handle component 12 and the tool 17 together in a quick connect configuration. When a user wishes to make a tool with the system 10, the tool shank 16 is directed toward the first end 24 of the handle component 12 as represented by arrow 100. The tool shank 16 is inserted into opening 92 of the handle component 16 and moved forward so that the tool shank modification 14 enters the shank cavity 34. As the tool shank modification 14 moves inwardly, a shank bevel 94 of the tool shank modification 14 contacts the shank retention bar 58. The shank retention bar 58 includes a bar bevel 96 that is of opposing angle to that of the shank bevel 92. The inward motion of the shank 16 into the shank cavity 34 causes the tool shank modification 14 to force the coupling button 36 to move downwardly, with the springs 50 being compressed as the spring pins 60 and 62 are forced downwardly into the button retention slot 48. When the forward movement of the tool shank modification 14 into the shank cavity 34 extends sufficiently that the notch 82 reaches the shank retention bar 58, the load on the springs 50 is partially released and the springs 50 force the coupling button 36 to move upwardly partially until the retention bar 58 makes contact with ceiling 98 of the notch 82, which halts movement of the coupling button 36 upwardly. The shank retention bar 58 thus becomes reversibly locked in the notch 82 so that the implement 17 is secured to the handle component 12 for secure use of the implement 17.

When the user wishes to disengage the implement 17 from the handle component 12, the coupling button 36 is compressed at button head 44. This causes the compression of the springs 50, forcing the coupling button 36 downwardly with pins 60 and 62 extending into the button retention slot 48. The shank retention bar 58 also moves downwardly until it exits the notch 82 of the tool shank modification 14. The user may then withdraw the tool shank 16 from the shank cavity 34, resulting in disengagement of the implement 17 from the handle component 12.

While the present invention has been described with reference to a specific example of the configuration of the quick connect tool interface system and its related components, it is to be understood that the invention is a broader concept defined by the following claims and reasonable equivalents directed to the combination of a unique tool handle component and a tool shank modification.

What is claimed is:

1. A quick connect tool interface system comprising:
a tool handle component including a handle body with a tool shank engagement section at an end thereof, wherein the tool shank engagement section includes a shank cavity and a coupling button; and
an implement including a tool shank having a tool shank modification, wherein the tool shank modification includes a button connector,
wherein the coupling button of the tool handle component is spring-loaded and configured with a shank retention bar arranged for reversible engagement with the tool shank modification.

2. The quick connect tool interface system as claimed in claim 1, wherein the shank cavity includes a shank receiving slot and a button retention slot that is substantially traverse to the shank receiving slot, wherein the button retention slot is configured to retain therein a pair of springs.

3. The quick connect tool interface system as claimed in claim 2, wherein the coupling button includes a shank pass-through port and a spring system.

4. The quick connect tool interface system as claimed in claim 3, wherein the spring system is affixed to an underside of the shank retention bar, and wherein the spring system and the shank retention bar are arranged for movable retention in the handle body.

5. The quick connect tool interface system as claimed in claim 1, wherein the tool shank engagement section of the handle component includes a gasket for sealing the interface between the tool shank modification and the handle component.

6. The quick connect tool interface system as claimed in claim 1, wherein the shank modification 14 includes a shank retention bar arranged for reversible engagement with the shank retention bar of the handle component.

7. The quick connect tool interface system as claimed in claim 1, wherein the tool shank modification includes a tool management port that can be used to secure the tool shank to a storage or carrying device.

8. The quick connect tool interface system as claimed in claim 1, wherein the tool shank engagement section is slotted or notched.

9. The quick connect tool interface system of claim 8, wherein the shank retention bar arranged for reversible engagement with a coupling button locking feature of the slotted or notched tool shank.
